(19) United States
(12) Patent Application Publication
(10) Pub. No.: US 2007/0222362 A1
(43) Pub. Date: Sep. 27, 2007

(54) Image display apparatus

(76) Inventors: Yuichi Sawai, Hitachi (JP); Osamu Shiono, Hitachi (JP); Motoyuki Miyata, Hitachinaka (JP); Hiroyuki Akata, Hitachi (JP); Yuichi Inoue, Mobara (JP); Takashi Naito, Mito (JP); Keiichi Kanazawa, Ome (JP); Kinya Kobayashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/293,211

(22) Filed: Dec. 5, 2005

(30) Foreign Application Priority Data
Dec. 6, 2004 (JP) 2004-352737

(51) Int. Cl. H01J 1/88; H01J 63/04; H01J 1/62

(52) U.S. Cl. 313/495; 313/292; 313/497

(57) ABSTRACT

An image display apparatus is provided which is capable of suppressing generation of cracks to be caused by a load applied to a partition disposed between an anode panel and a cathode panel. The partition for retaining a predetermined distance between back and front substrates by using bonding material is constituted of a partition main body and an electric conducting layer coated on the outer peripheral surface of the partition main body. The partition main body has curved portions at the corners of upper and lower end portions, the curved portions contacting the back and front substrates. It is possible to prevent damages of an electrode to be caused by a mechanical load applied to cathode and anode panels having electrodes on opposing surfaces.

### CROSS-REFERENCE TO RELATED APPLICATION

This application relates to an application U.S. Ser. No. being filed based on Japanese patent application No. 2004-372090 filed on Dec. 22, 2004, assigned to Hitachi Limited.

### BACKGROUND OF THE INVENTION

1. Field of the Invention

The present invention relates to a luminescence type flat panel image display apparatus utilizing electron emission in vacuum, and more particularly to an image display apparatus having a display panel structured by disposing a plurality of partitions for holding a cathode panel and an anode panel at a predetermined space. The cathode panel has electron sources for emitting electrons by electric field emission, and the anode panel has an electron acceleration electrode and fluorescent material layers of plural colors which become luminous by excitation of electrons extracted from the cathode panel.

2. Description of the Related Art

Color cathode ray tubes have been used conventionally as a display device excellent in high luminance and high precision. However, recent high image quality of information processing apparatus and television broadcasting is increasing the demands for flat panel image display apparatus providing not only the characteristics of high luminance and high precision but also lightness in weight and space reduction.

As typical examples, a liquid crystal display apparatus, a plasma display apparatus and the like are practically used. Practical use of panel type display apparatus of various kinds is expected in the near future, such as an electron emission type display apparatus or an electric field emission type display apparatus utilizing electron emission from electron sources in vacuum and an organic EL display characterized in low consumption power. In this specification, an image display apparatus is intended to mean a plasma display apparatus, an electron emission type display apparatus or an organic EL display apparatus which is not required to have an auxiliary illumination light source.

Of these image display apparatus, electric field emission type display apparatus include: an apparatus having a cone type electron emission structure devised by C. A. Spindt, et al; an apparatus having a metal—insulator—metal (MIM) type electron emission structure; an apparatus having an electron emission structure (also called a surface conduction type electron source) utilizing an electron emission phenomenon by the quantum tunnel effect; and an apparatus utilizing an electron emission phenomenon of nanotubes and the like, typically diamond films, graphite films and carbon nanotubes.

A display panel constituting an electric field emission type display apparatus as an example of the image display apparatus has a cathode panel and an anode panel. The cathode panel has a first electrode (e.g., a cathode electrode, a signal electrode, a data electrode) having therein an electron source of an electric field emission type and a second electrode (e.g., a gate electrode, a scan electrode) as a control electrode. The anode panel has therein fluorescent material layers of plural colors and a third electrode, respectively facing the cathode panel. The anode panel is made of transparent glass material, preferably glass.

Both panels are sealed by inserting a sealing frame in the inner bonding peripheral edges, and the inner space of the structure constituted of the cathode panel, front or anode panel and sealing frame is evacuated. The cathode panel has a back substrate made of insulating material, preferably glass, alumina or the like. Formed on this back substrate are: a plurality of first electrodes having a number of electron sources extending along a first direction and juxtaposed along a second direction crossing the first direction; and a plurality of second electrodes having a number of electron sources extending along the second direction and juxtaposed along the first direction.

The electron source is disposed at a cross point between the first and second electrodes, and an emission quantity (including on and off of emission) of electrons from the electron source is controlled by a potential difference between the first and second electrodes. Emitted electrons are accelerated by a high voltage applied to the third electrode of the anode panel, and bombarded on the fluorescent material layer of the anode panel to generate coloring corresponding to the luminescence properties of the fluorescent material layer.

Each electron source paired with a corresponding fluorescent material layer constitutes a unit pixel (picture element). Generally, unit pixels of three colors, red (R), green (G) and blue (B) constitute one pixel (also called a color pixel or a pixel). The unit pixel of the color pixel is also called a subsidiary pixel (sub-pixel).

The sealing frame is adhered to the inner bonding peripheral edges of the cathode panel and anode panel with adhesive such as frit glass. A vacuum degree in an air-tight glass container constituted of the cathode panel, anode panel and sealing frame is, for example, 10⁻⁵ to 10⁻⁷ Torr. In the case of a panel having a large screen size, a plurality of partitions (also called spacers or space holding members) are involved between the cathode and anode panels to fix the panels and maintain a predetermined distance between the panels. This partition is a plate member made of insulating material such as glass and ceramics or material having conductivity to some extent, one partition per a plurality of pixels is disposed at a position not hindering the operation of pixels.

Various studies have been made on installing the partitions for maintaining the predetermined distance between the cathode and anode panels, including the structure not deflecting a trajectory of an electron beam to be caused by charge-up of the partitions, the structure preventing break of the partitions by improving the partition layout, the structure preventing discharge, and the like.

Examples of the charge-up countermeasure are disclosed, for example, in JP-A-57-118355 and JP-A-61-124031 which propose the structure that small current is flowed through the partitions in order for the trajectory of an electron beam not to be deflected. JP-A-2000-251649 discloses the structure that the partition has the cross sectional shape of a trapezoid, a hexagon or ellipsoid with a swelled central portion and has the structure broadening the side walls from the electron source toward the direction of a portion irradiated with an electron beam, in order not to deflect a trajectory of an electron beam by not providing the conductivity characteristics of the partition.

An example of a partition break countermeasure is disclosed in JP-A-2004-14131 which proposes the structure that an inclination angle of the end plane in the partition cross sectional shape relative to a horizontal central plane and a vertical central plane is set to 85° to 95°. JP-A-2004-14131 discloses the structure that a ratio of a partition cross sectional width to a partition cross sectional height is set to 2 to 50% in order to improve the partition layout and a flat portion ratio of a flat portion length of the top and bottom planes to the cross sectional width is set to 40 to 95%.

Another example of a partition break countermeasure is disclosed in JP-A-2000-285829 which proposes the structure that a coating thickness of frit glass to be coated beforehand on the cathode panel is made thicker than a coating thickness of frit glass to be coated on the cathode panel to fix the partitions in such a manner that only the sealing frame made of a thicker plate contacts and the partitions made of thinner plates do not contact. Therefore, the partitions can be fixed to the cathode panel or anode panel in a bonding process without break and the structure is independent from a variation due to a processing precision of the partitions.

An example of a discharge prevention countermeasure is disclosed in JP-A-2003-317652 which proposes the partition structure that the side wall of the partition is slanted to face the surface of the fluorescent material layers, i.e., an orthogonal projection of the partition cross section upon the substrate plane includes the bonding area, because the region near the end of the partition along the longitudinal direction is likely to become the cause of discharge.

However, as shown in a main part enlarged cross sectional view of FIG. 18, a very large load LD is applied to each partition SPC. This is because since the inside of the air-tight glass container constituted of the cathode panel, anode panel and sealing frame of the image display apparatus constructed as above is maintained at a high vacuum degree of about 1 μPa, the partition SPC is bonded to the second electrode (gate electrode) GL formed on the surface of a panel glass SUB constituting the cathode panel, with a bonding material FGS and a very large load LD is applied to each partition SPC.

The partition SPC has a relatively small strength against the large load LD and is likely to be broken, because as described earlier, the partition is formed by cutting in a proper size a plate made of insulating material such as glass and ceramics or material having conductivity to some extent. Therefore, as shown in a main part plan view of FIG. 19, an increased number of partitions SPC per inch are mounted in a display area AR in order to retain the panel strength.

If the partition SPC is made of a high strength glass plate, the panel strength can be retained by mounting an decreased number of partitions per inch in the display area AR as shown in a main part plan view of FIG. 20. On the other hand, as shown in a main part enlarged cross sectional view of FIG. 21, there arises an issue that when the partition SPC is mounted on the panel glass SUB, the bonding material FGS on the gate electrode GL formed on the surface of the panel glass SUB may be broken by the load LD or a crack CRK may be formed in the panel glass SUB.

In order to solve this issue, there arise new other issues such as the requirements for a mount precision of mounting the partition SPC on the gate electrode GL and the requirements for a coating precision of the bonding material FGS.

There arises therefore an issue of degraded reliability of the image display apparatus, because the crack CRK is likely to be formed in the panel glass SUB so that this crack may become a generation source of vacuum leakage, resulting in a low air-tight state and a deteriorated vacuum degree in the inner space (in the air-tight space) constituted of the panel glass SUB and sealing frame.

There arises an issue of degraded reliability of the image display apparatus to be caused by lowered conductivity and corresponding broken wiring due to damages of the gate electrode GL and the like.

### SUMMARY OF THE INVENTION

The present invention has been made in order to solve the above-described conventional issues, and an object of the present invention is to provide an image display apparatus having a high reliability display panel capable of suppressing formation of cracks to be caused by a load applied to each partition disposed between anode and cathode panels without involvement of deteriorated conductivity and vacuum degree.

Another object of the present invention is to provide an image display apparatus having a display panel capable of resisting against a predetermined high load by installing a decreased number of partitions to be disposed between cathode and anode panels.

In order to achieve the above objects, an image display apparatus of the present invention comprises: a back panel having a display area with a number of pixels formed on a back substrate, the pixels including a number of first electrodes extending along a first direction and juxtaposed along a second direction crossing the first direction, an insulating layer covering the first electrodes, a number of second electrodes formed on the insulating layer, extending along the second direction and juxtaposed along the first direction, and an electron source disposed at each cross point between the first and second electrodes; an anode panel having fluorescent material layers of a plurality of colors and a third electrode formed on a front substrate, the fluorescent material layers emitting light upon excitation of electrons emitted from the electron sources in the display area of the cathode panel; a plurality of partitions for maintaining a distance between the cathode panel and anode panel at a predetermined distance by involving a fixing member between the panels in the display area; and a sealing frame for air-tightly sealing the cathode panel and anode panel by involving a sealing material in peripheral areas of the panels, wherein the partition includes a partition main body having curved portions at corners of upper and lower end portions contacting the cathode panel and anode panel and an electric conducting layer coated at least on the upper and lower end portions of the partition main body contacting the cathode panel and anode panel. Accordingly, the cathode panel and anode panel having electrodes on opposing inner surfaces are hard to be damaged due to mechanical strength, so that the above-described prior art issues can be solved.

In another image display apparatus of the present invention having the above-described configuration, the partition main body is preferably a mold of glass material (hereinafter called glass containing rare-earth elements) having SiO₂ as a main component and containing 1 to 20 wt. % of at least one material selected from a group consisting of La, Sc, Y, Ce, Pr, Nd, Pm, Sm, Eu, Gd, Tb, Dy, Ho, Er, Tm, Yb and Lu. Accordingly, the mechanical strength is improved and a large buckling load can be obtained, so that the above-described prior art issues can be solved.

In another image display apparatus of the present invention having the above-described configuration, non-oxidizing metal is preferably used as the material of the conductive metal film formed at least the upper and lower end portions of the partition. Since charge-up of the partition can be drained, the above-described prior art issues can be solved.

In another image display apparatus of the present invention having the above-described configuration, a conductive wire is embedded in the upper and lower end portions of the partition main body along the longitudinal direction. Since charge-up on the partition can be drained, the above-described prior art issues can be solved.

The present invention is not limited to the above-described structures and the structures of embodiments to be later described, but it is obvious that various modifications are possible without departing from the technical concept of the present invention.

According to the image display apparatus of the present invention, the partition includes a partition main body having curved portions at corners of upper and lower end portions contacting the cathode panel and anode panel and an electric conducting layer coated at least on the upper and lower end portions of the partition main body contacting the cathode panel and anode panel. Accordingly, the image display apparatus of high reliability and high quality can be realized and very excellent effects can be obtained, because only a small number of partitions are bonded and firmly fixed, without damaging the electrodes to be caused by the partitions mounted between the cathode panel and anode panel, and being independent from a coating precision and mount precision of the bonding material. The influence of charges on the partitions upon an electron trajectory can be eliminated, an insufficient luminance due to insufficient excitation of the fluorescent material layers can be prevented, so that an image display apparatus having high color reproduction can be realized and very excellent effects can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic plan view illustrating the structure of an image display apparatus according to a first embodiment of the present invention.

FIG. 2 is an enlarged cross sectional view taken along line A-A′ of FIG. 1.

FIG. 3 is a main part enlarged cross sectional view of FIG. 2.

FIGS. 4A and 4B are main part enlarged views showing the detailed structure of the partition shown in FIG. 3, FIG. 4A is a perspective view and FIG. 4B is a cross sectional view.

FIG. 5A and 5B are cross sectional views showing the mount structure of the partition shown in FIGS. 4A and 4B.

FIGS. 6A and 6B are diagrams showing a partition according to another embodiment of the present invention.

FIGS. 7A, 7B and 7C are diagrams illustrating a buckling load evaluation test for the partition shown in FIGS. 6A and 6B, FIG. 7A is an enlarged cross sectional view of the partition, FIG. 7B is a main part enlarged cross sectional view of the partition applied to an image display apparatus, and FIG. 7C is a cross sectional view showing the structure of a buckling text sample.

FIGS. 8A, 8B and 8C are main part enlarged cross sectional views illustrating a relation between a width of a partition central portion and a buckling load.

FIGS. 9A and 9B are cross sectional views illustrating a buckling load evaluation test for a partition having an inclination angle and installed between both substrates.

FIGS. 10A, 10B and 10C are perspective views showing the structure of a partition according to another embodiment of the present invention.

FIG. 11 is a perspective view showing the structure of a partition according to another embodiment of the present invention.

FIGS. 12A and 12B are diagrams illustrating a partition manufacture method according to the present invention.

FIGS. 13A to 13E are plan views showing metal molds of a glass reflow system shown in FIG. 12B.

FIG. 14 is a diagram showing the outline shape of glass preforms.

FIG. 15 is a diagram showing the surface structure of a glass preform.

FIGS. 16A and 16B are diagrams illustrating an example of application of an image display apparatus of the present invention to a 17-inch type image display apparatus.

FIG. 17 is a diagram showing an example of an equivalent circuit of an image display apparatus to which the configuration of the present invention is applied.

FIG. 18 is a main part enlarged cross sectional view illustrating an issue of an assembly precision of a conventional partition.

FIG. 19 is a main part plan view showing an example of the layout of conventional low strength partitions.

FIG. 20 is a main part plan view showing an example of the layout of conventional high strength partitions.

FIG. 21 is a main part enlarged cross sectional view illustrating an issue of an assembly precision of a conventional partition.

### DESCRIPTION OF THE EMBODIMENTS

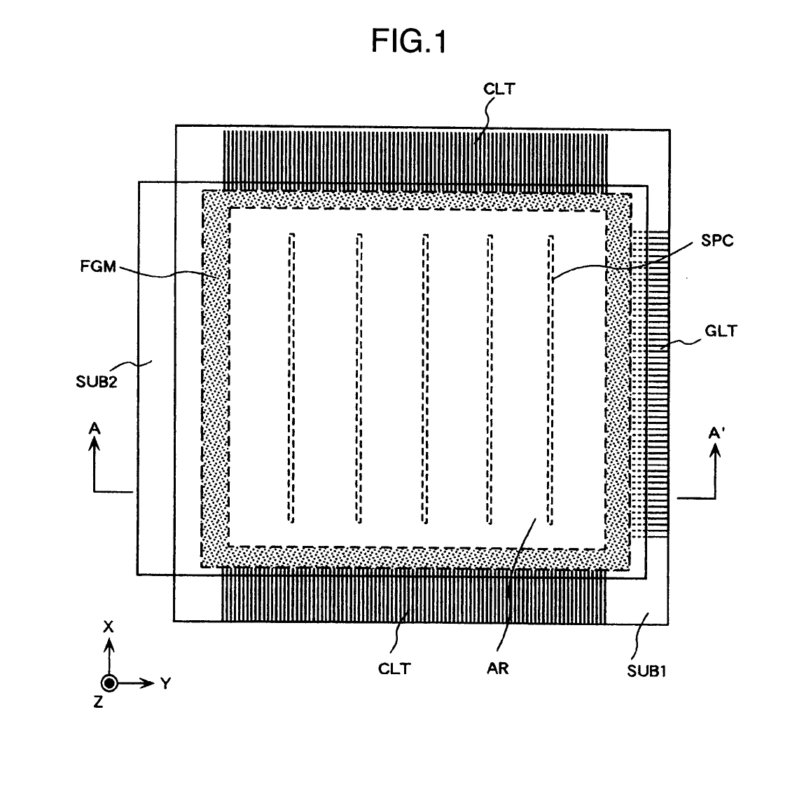

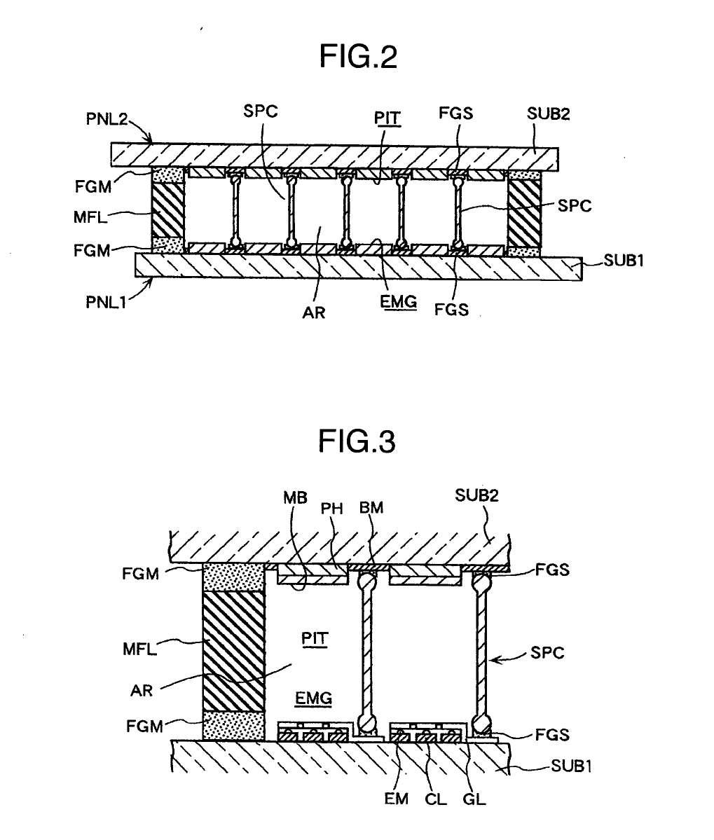

Embodiments of the invention will be described in detail with reference to the accompanying drawings. First, with reference to FIGS. 1 and 2, description will be made on the first embodiment of the invention.

### First Embodiment

FIGS. 1 to 3 show an image display apparatus according to the first embodiment of the present invention. FIG. 1 is a schematic plan view showing the outline structure of the image display apparatus as viewed from an anode panel side, FIG. 2 is a schematic cross sectional view taken along line A-A′ shown in FIG. 1, and FIG. 3 is a main part enlarged cross sectional view of FIG. 2.

In these drawings, reference symbol SUB1 represents a back substrate constituting a cathode panel PNL1, SUB2 represents a front substrate constituting an anode panel PNL2, MFL represents a sealing frame, SPC represents a partition, EMG represents an electron emission element group, CL represents a cathode electrode, CLT represents a cathode electrode lead terminal, EM represents an electron source, GL represents a gate electrode, GLT represents a gate electrode lead terminal, PIT represents an image forming member, PH represents a fluorescent material layer, MB represents a metal back film (anode), BM represents a black matrix film, FGM represents a sealing material, FGS represents a bonding material, and AR represents a display region.

In the structure described above, the back substrate SUB1 is an insulating substrate having a thickness of several mm, e.g., about 3 mm and is preferably made of a glass plate or a ceramic plate such as an alumina plate. The front substrate SUB2 is a transparent substrate having a thickness of several mm, e.g., about 3 mm and is preferably made of a transparent glass substrate or the like.

The sealing frame MFL also serving as an outer frame and disposed at the peripheral areas between the back substrate SUB1 and front substrate SUB2 is made of a glass plate or a mold of frit glass. The sealing frame is fixed between the back substrate SUB1 and front substrate SUB2 with the sealing material FGM to maintain the distance between the back substrate SUB2 and front substrate SUB1 at a predetermined value, e.g., about 3 mm. In this embodiment, frit glass containing lead oxide (PbO) is used as the material of the sealing material FGM.

An outer surface of a main body of the partition SPC made of a mold of glass material containing rare-earth elements to be described later is coated with a charge preventive electric conducting layer. In the display area AR formed being sandwitched between the back substrate SUB1 and front substrate SUB2, a plurality of partitions are disposed generally vertically at a predetermined pitch along one direction (x-direction) aligned with the longitudinal direction of the partitions SPC to form a column, and a plurality of columns are juxtaposed at a predetermined pitch along another direction (y-direction) crossing the one direction. Each partition is disposed fixedly at a predetermined position between the back substrate SUB1 and front substrate SUB2, e.g., between the gate electrode GL formed on the back substrate SUB1 and the black matrix film BM formed on the inner surface of the front substrate SUB2 by using the bonding material FGS containing conductive components. Fixing the partition is realized by melting and solidifying the bonding material FGS. In this embodiment, the bonding material FGS is made of frit glass containing lead oxide (PbO) having different melting and solidifying temperatures from those of the sealing material FGM.

Next, the structure of the partition SPC will be described in detail.

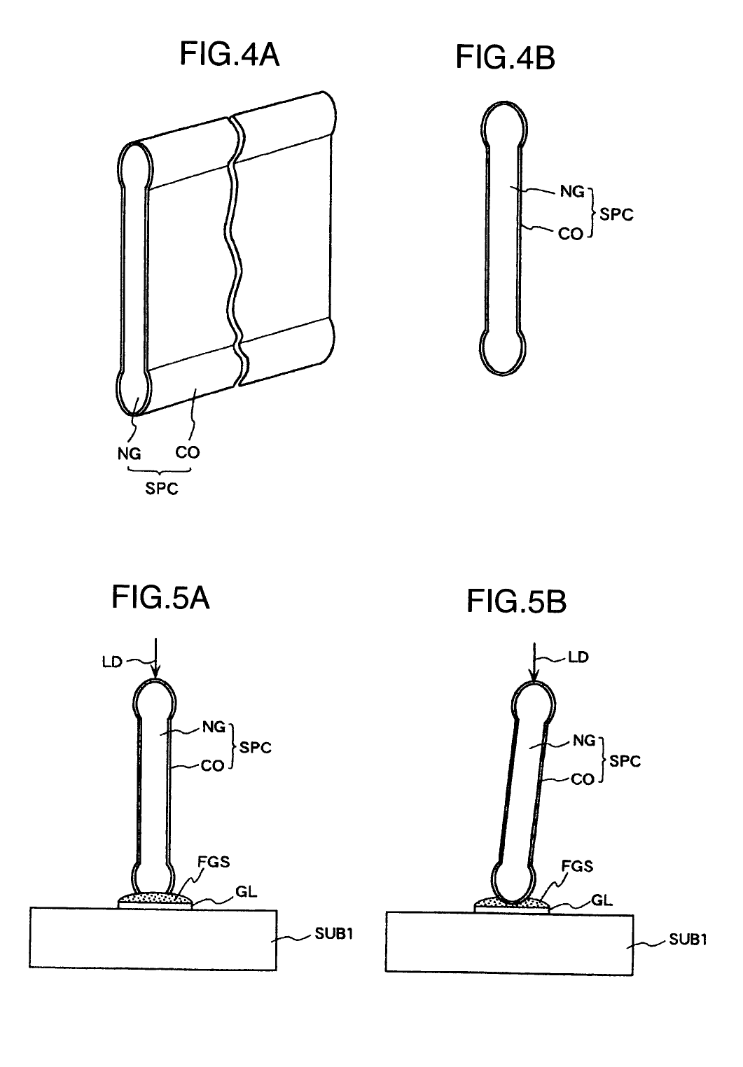

FIGS. 4A and 4B illustrate the structure of the partition SPC. FIG. 4A is a main part perspective view, and FIG. 4B is a cross sectional view. As shown in FIGS. 4A and 4B, a partition main body NG of the partition SPC has spherical members at its upper and lower end portions contacting the back substrate SUB1 and front substrate SUB2 shown in FIG. 3 and plate members integrally coupling the spherical members at both end portions. An electric conducting layer CO is coated on the outer peripheral surface of the partition main body. Each edge portion at upper and lower end portions contacting the cathode panel PNL1 and anode panel PNL2 has a curved portion.

The electric conducting layer CO may be formed by a sol-gel method, a sputtering method or a CVD method. Since the electric conducting layer CO is formed uniformly, an electric field distribution in the panel becomes uniform and equipotential surfaces become parallel, so that electrons emitted from the electron emission source move straightforward. However, depending upon the shape of the electron emission source, the electric field distribution may become irregular. In this case, electrons will not move straightforward. Equipotential surfaces can be made parallel and electrons can move straightforward, by inclining a surface resistance of the electric conducting layer CO along a height direction or by other methods.

The partition main body NG is formed by molding glass material containing rare-earth elements by a redraw method using a glass reflow system. Therefore, the partition main body NG has a glass strength five to six times higher than that of general glass material, is light in weight and can be formed at low cost. Glass containing rare-earth elements has a flexural strength of about 200 MPa or higher, a Weibull factor of about 8.0 or higher and a Young's modulus of about 80 Gpa or larger.

The partition main body NG is coated with a silica film (not shown) to form fine convex/concave surfaces so that tight adhesion and conductivity of the electric conducting layer CO formed on the silica film can be improved and it is possible to prevent emission of secondary electrons to be caused by charges formed by electron radiation from the electron source.

The electric conducting layer CO is coated on the partition main body NG by dipping the partition main body in solution of mixed inorganic binder and ATO or PTO, and thereafter the partition main body is cured for 30 minutes at about 450° C. A thickness of the electric conducting layer CO is in a range of 60 nm to 70 nm, and its surface electrical resistance is about 5.0 E+9 to 5.0 E+11 Ω/□]. Under these conditions, cracks of the electric conducting layer CO were found not at all.

As shown in a main part enlarged cross sectional view of FIG. 5A, the edge portion at the lower end of each partition SPC contacting the back substrate SUB1 has the curved portion. Therefore, when the partition SPC constructed as above is mounted on the back substrate SUB1 formed with the gate electrode GL by using the bonding material FGS, the edge portion is bonded and fixed to the bonding material FGS in a rolled state relative to a load LD applied to the partition SPC. The gate electrode GL will not be damaged.

As shown in a main part enlarged cross sectional view of FIG. 5B, when the partition SPC is mounted in a slanted state, the edge portion rolls laterally in the bonding material FGS and bonded and fixed. Therefore, the partition SPC is bonded and fixed in the same bonding area, irrespective of the inclination angle and a coating precision of the bonding material FGS. The gate electrode GL will not be damaged therefore. Although not shown, damages to be caused by the load LD applied to the partition SPC will not occur also at the black matrix film (anode) BM formed on the inner surface of the front substrate SUB2 facing the back substrate.

Since the whole surface of the partition main body NG of the partition SPC constructed as above is coated with the electric conducting layer CO, charge-up of the partition SPC can be flowed out easily by connecting the electric conducting layer to a ground line (not shown).

### Second Embodiment

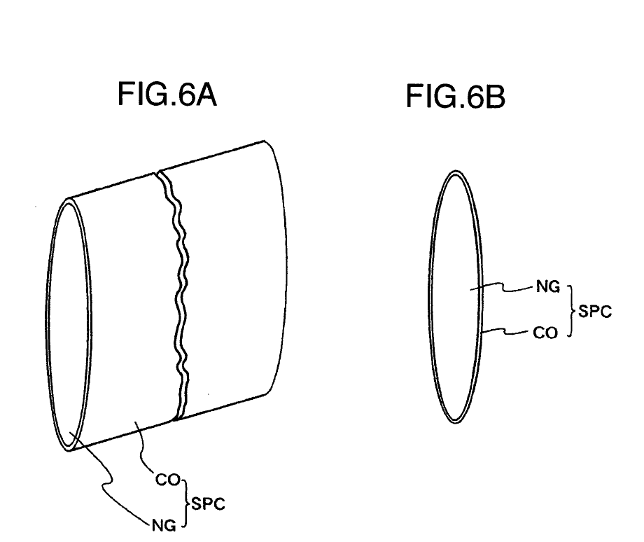

FIGS. 6A and 6B are diagrams illustrating the structure of a partition SPC according to the second embodiment of the present invention. FIG. 6A is a main part perspective view and FIG. 6B is a cross sectional view. Like elements to those in the already described drawings are represented by identical reference symbols, and the description thereof is omitted. A different point of FIGS. 6A and 6B from FIGS. 4A and 4B resides in that the partition SPC has a vertically elongated ellipsoidal shape and the cross section of the partition main body NG has a width of a central portion wider than a width of upper and lower end portions as viewed in a cross section along a direction toward the back substrate and opposing front substrate.

Similar to the first embodiment, the partition main body NG is formed by molding glass material containing rare-earth elements by a redraw method using a glass reflow system. The partition main body NG is also coated with a silica film (not shown) to form fine convex/concave surfaces so that tight adhesion, conductivity and the like of the electric conducting layer CO formed on the silica film can be improved.

The partition SPC constructed as above has a vertically elongated ellipsoidal shape and the cross section of the partition main body NG has a width of a central portion wider than a width of upper and lower end portions as viewed in a cross section along a direction toward the back substrate SUB1 and opposing front substrate. Since the width of the central portion is wider, the partition can resist against a large buckling load so that the partition is very effective for retaining a predetermined distance between the back substrate and front substrate.

Since the whole surface of the partition main body NG of the partition SPC constructed as above is coated with the electric conducting layer CO, charge-up of the partition SPC can be flowed out easily by connecting the electric conducting layer to a ground line (not shown). Further, since a length of the partition is not limited by the redraw method, the partition having a length of, for example, 700 mm to 1000 mm or longer, can easily be formed.

Although the partition SPC of the second embodiment described above has the vertically elongated ellipsoidal shape, the present invention is not limited to this shape, but it is obvious that a vertically elongated octagonal shape may also be used with similar effects.

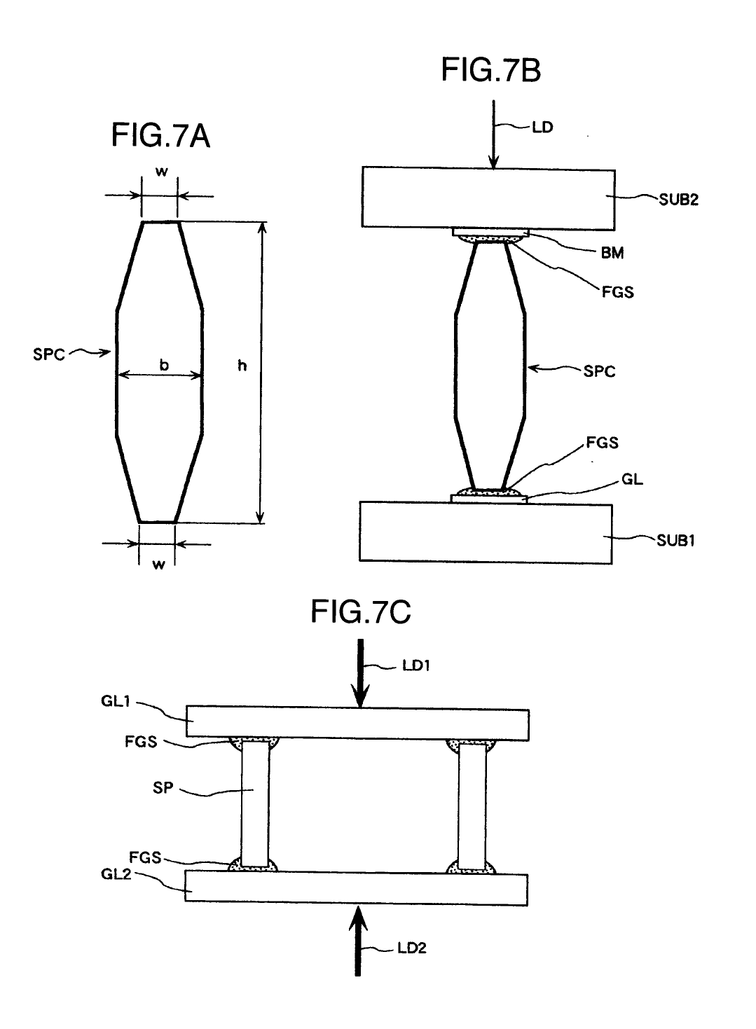

FIGS. 7A, 7B and 7C are diagrams illustrating a buckling load evaluation test for partitions SPC according to the prior art and the embodiment. FIG. 7A is an enlarged cross sectional view of a partition SPC, FIG. 7B is a main part enlarged cross sectional view of an image display apparatus, and FIG. 7C is a cross sectional view showing buckling load test samples of partitions. A height between upper and lower ends of the partition SPC was set to h and a width of a central portion was set to b as shown in FIG. 7A, and the partition SPC was bonded and fixed between the back substrate SUB1 and front substrate SUB2 by using the bonding material FGS as shown in FIG. 7B, and a breaking test of a cross sectional shape and material quality relative to a load LD applied to the partition SPC was conducted.

A buckling strength test was conducted and a buckling load was evaluated for samples of partitions SPC made of soda-glass material and glass material containing rare-earth elements, with a partition upper/lower end width of about 100 μm, a height of about 3 mm±5 μm and a length of about 110 mm being fixed and central area width b being changed in a range of 100 μm to 250 μm.

As shown in FIG. 7C, two partitions SP are sandwiched between glass plates GL1 and GL2 and bonded by using a sealing material FGS to form a buckling test sample. Eight samples of partitions SP having each cross sectional shape were formed, compressive loads LD1 and LD2 were applied along arrow directions by using tensile-compression testing equipment (Shimadzu Corporation: AutoGraph), and a load was measured when the partition SP is buckled. The measurement results are shown in Table 1.

TABLE 1

| | h(mm) | b(μm) | material | buckling load (kN) |
|---|---|---|---|---|
| Comparative | 3.0 | 100 | soda | 6.4 |
| example 1 | | | glass | |
| Comparative | 3.0 | 150 | soda | 9.6 |
| example 2 | | | glass | |
| Comparative | 3.0 | 200 | soda | 12.8. |
| example 3 | | | glass | |
| Comparative | 3.0 | 250 | soda | 16.0 |
| example 4 | | | glass | |
| Comparative | 3.0 | 100 | glass | 8.0 |
| example 5 | | | containing | |
| | | | rare earth | |
| | | | element | |
| Comparative | 3.0 | 100 | glass | 12.0 |
| example 6 | | | containing | |
| | | | rare earth | |
| | | | element | |
| Comparative | 3.0 | 100 | glass | 16.0 |
| example 7 | | | containing | |
| | | | rare earth | |
| | | | element | |
| Comparative | 3.0 | 250 | glass | 20.0 |
| example 8 | | | containing | |
| | | | rare earth | |
| | | | element | |
| Comparative | 3.0 | 100 | soda | 3.8 |
| example 9 | | | glass | |
| Comparative | 5.0 | 100 | soda | 5.8 |
| example 10 | | | glass | |
| Comparative | 5.0 | 150 | soda | 7.7 |
| example 11 | | | glass | |
| Comparative | 5.0 | 250 | soda | 9.6 |
| example 12 | | | glass | |
| Comparative | 5.0 | 100 | glass | 4.8 |
| example 13 | | | containing | |
| | | | rare earth | |
| | | | element | |
| Comparative | 5.0 | 150 | glass | 7.2 |
| example 14 | | | containing | |
| | | | rare earth | |
| | | | element | |
| Comparative | 5.0 | 200 | glass | 9.6 |
| example 15 | | | containing | |
| | | | rare earth | |
| | | | element | |
| Comparative | 5.0 | 250 | glass | 12.0 |
| example 16 | | | containing | |
| | | | rare earth | |
| | | | element | |

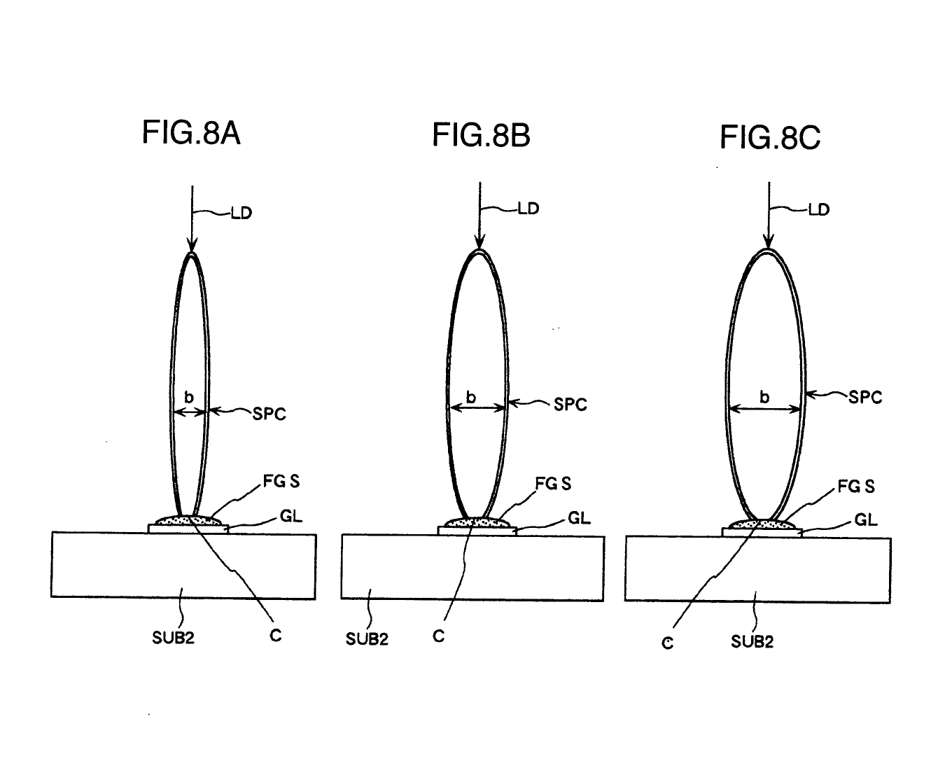

As apparent from Table 1, it was confirmed that a larger buckling load was obtained and it was very effective for retaining the distance between the back substrate and front substrate, as the width b of the central portion of the partition SP made of glass material containing rare-earth elements was made wider by fixing almost the same area of a bonding portion C of the sealing material FGS, as shown in main part enlarged cross sectional views of FIGS. 8A, 8B and 8C. As the central portion width b is made wider, a larger buckling load can be obtained. However, as the central portion width b exceeds about 200 μm, arrival of emission electrons to the fluorescent material layer is hindered. It is therefore preferable to set the central portion width in a range of 100 μm to 200 μm.

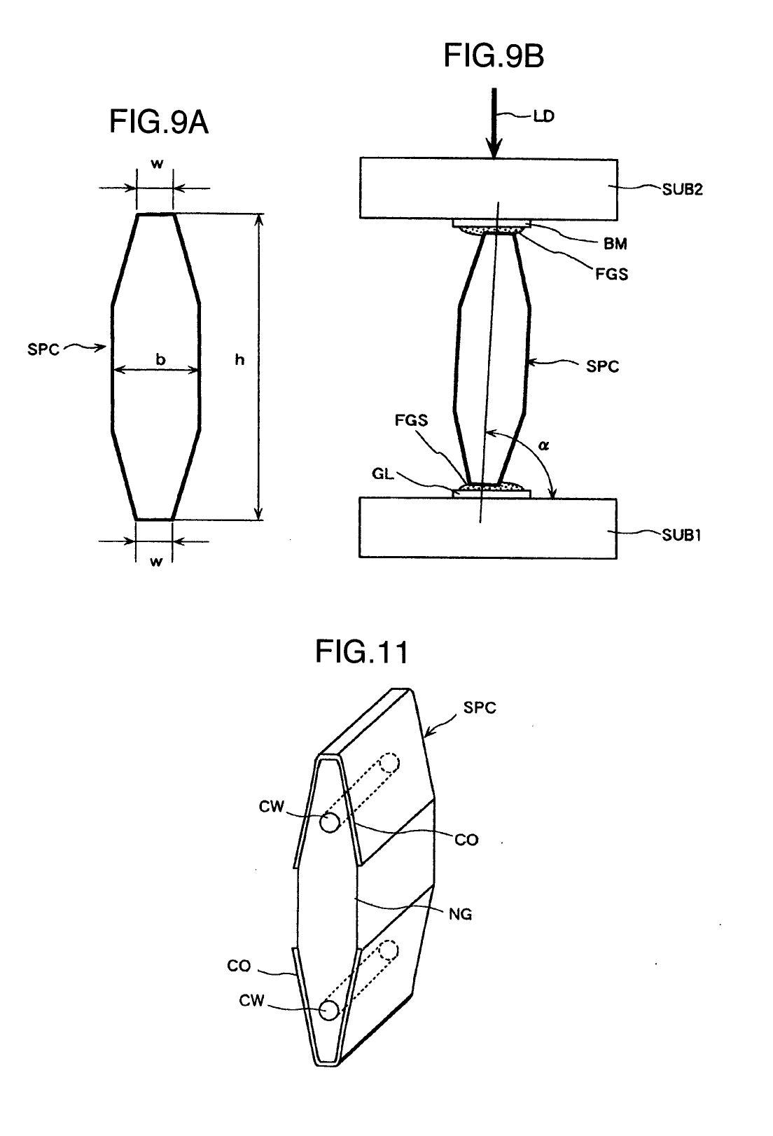

FIGS. 9A and 9B are diagrams illustrating a buckling load evaluation test for an inclination angle of partitions SPC according to the prior art and the embodiment. FIG. 9A is an enlarged cross sectional view of a partition SPC, and FIG. 9B is a main part enlarged cross sectional view of an image display apparatus. A height h between upper and lower ends of the partition SPC was fixed to about 3.0 mm and a length was fixed to about 110 mm as shown in FIG. 9A, the partition SPC was bonded and fixed between the back substrate SUB1 and front substrate SUB2 by using the bonding material FGS as shown in FIG. 9B, and a break-down strength test of a cross-sectional shape and material quality relative to a load LD applied to the partition SPC was conducted.

Twelve samples of the partition SPC made of soda glass material and twelve samples of the partition SPC made of glass material containing rare-earth elements were formed by changing the central portion width b in a range of 100 to 250 μm and the inclination angle α in a range of 80° to 90°, and a break-down strength test was conducted. A break-down stress evaluation results are shown in Table 2.

TABLE 2

| | | inclination | | buckling load |
|---|---|---|---|---|
| | b(μm) | angle (°) | material | (kN) |
| Comparative | 100 | 80 | soda | 6.0 |
| example 1 | | | glass | |
| Comparative | 150 | 80 | soda | 9.0 |
| example 2 | | | glass | |
| Comparative | 200 | 80 | soda | 12.0. |
| example 3 | | | glass | |
| Comparative | 250 | 80 | soda | 15.0 |
| example 4 | | | glass | |
| Comparative | 100 | 85 | soda | 7.2 |
| example 5 | | | glass | |
| Comparative | 150 | 85 | soda | 10.8 |
| example 6 | | | glass | |
| Comparative | 200 | 85 | soda | 14.4 |
| example 7 | | | glass | |
| Comparative | 250 | 85 | soda | 18.0. |
| example 8 | | | glass | |
| Comparative | 100 | 90 | soda | 8.0 |
| example 9 | | | glass | |
| Comparative | 150 | 90 | soda | 12.0 |
| example 10 | | | glass | |
| Comparative | 200 | 90 | soda | 16.0 |
| example 11 | | | glass | |
| Comparative | 250 | 90 | soda | 20.0 |
| example 12 | | | glass | |
| Comparative | 100 | 80 | glass | 7.2 |
| example 13 | | | containing | |
| | | | rare earth | |
| | | | element | |
| Comparative | 150 | 80 | glass | 10.8 |
| example 14 | | | containing | |
| | | | rare earth | |
| | | | element | |
| Comparative | 200 | 80 | glass | 14.4 |
| example 15 | | | containing | |
| | | | rare earth | |
| | | | element | |
| Comparative | 250 | 80 | glass | 18.0 |
| example 16 | | | containing | |
| | | | rare earth | |
| | | | element | |
| Comparative | 100 | 85 | glass | 8.6 |
| example 17 | | | containing | |
| | | | rare earth | |
| | | | element | |
| Comparative | 150 | 85 | glass | 13.0 |
| example 18 | | | containing | |
| | | | rare earth | |
| | | | element | |
| Comparative | 200 | 85 | glass | 17.3 |
| example 19 | | | containing | |
| | | | rare earth | |
| | | | element | |
| Comparative | 250 | 85 | glass | 21.6 |
| example 20 | | | containing | |
| | | | rare earth | |
| | | | element | |
| Comparative | 100 | 90 | glass | 9.6 |
| example 21 | | | containing | |
| | | | rare earth | |
| | | | element | |
| Comparative | 150 | 90 | glass | 14.4 |
| example 22 | | | containing | |
| | | | rare earth | |
| | | | element | |
| Comparative | 200 | 90 | glass | 19.2 |
| example 23 | | | containing | |
| | | | rare earth | |
| | | | element | |
| Comparative | 250 | 90 | glass | 24.0 |
| example 24 | | | containing | |
| | | | rare earth | |
| | | | element | |

As apparent from Table 2, as the central portion width b of the partition SPC becomes wide, the buckling strength becomes high irrespective of material. An allowance range of an inclination angle a becomes wide if glass containing rare-earth elements is used, as compared to soda glass. It was confirmed that the partition having an octagonal cross sectional shape 10 and made of glass containing rare-earth elements was very effective for supporting the back substrate SUB1 and front substrate SUB2.

### Third Embodiment

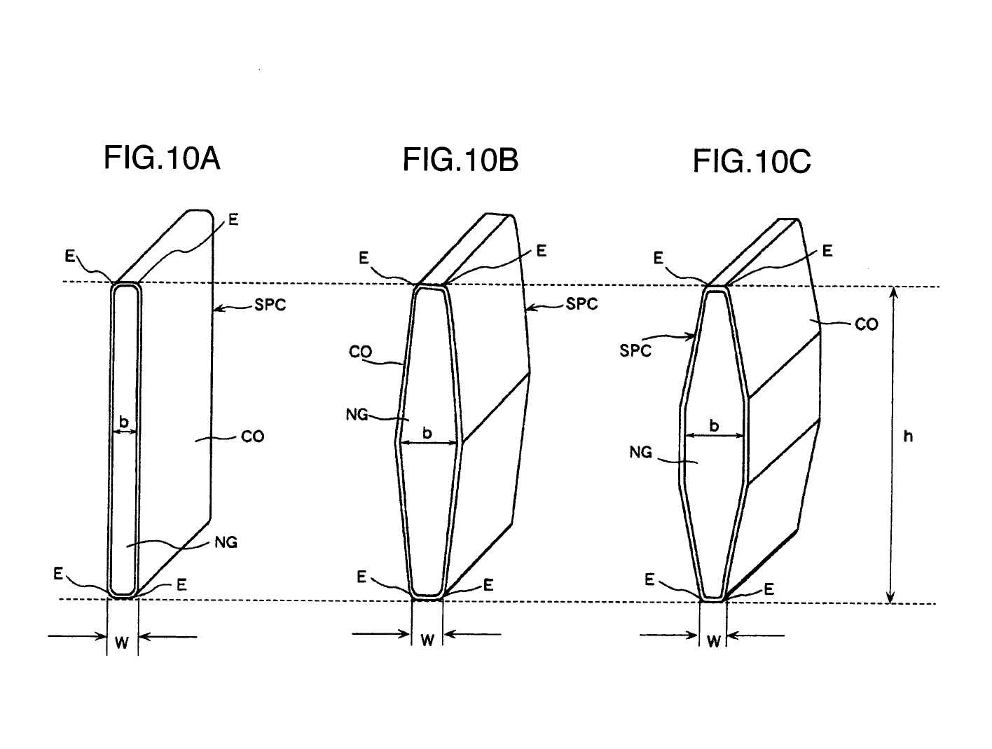

FIGS. 10A, 10B and 10C are perspective views illustrating the structure of partitions SPC according to the third embodiment of the present invention. Like elements to those in the already described drawings are represented by identical reference symbols, and the description thereof is omitted. A partition SPC shown in FIG. 10A has a partition main body NG made of a plate mold of glass material containing rare-earth elements, and each edge portion E has a curved plane having a diameter of curvature of about several μm to present the structure improving wettability (adhesion) to a bonding material (not shown). An electric conducting layer CO is coated on the outer peripheral surface of the partition SPC.

A partition SPC shown in FIG. 10B has a partition main body NG made of a plate mold of glass material containing rare-earth elements. The shape of the partition main body NG is a vertically elongated hexagonal shape and the cross section thereof has a width of a central portion wider than a width of upper and lower end portions as viewed in a cross section along a direction toward the back substrate and opposing front substrate (not shown). Each edge portion E has a curved plane having a diameter of curvature of about several μm to present the structure improving adhesion to a bonding material (not shown). An electric conducting layer CO is coated on the outer peripheral surface of the partition SPC. The size of this partition SPC has an upper and lower end portion width W of about 100 μm, a central portion width b of about 200 μm and a height h of about 3 mm±5 μm.

A partition SPC shown in FIG. 10C has a partition main body NG made of a plate mold of glass material containing rare-earth elements. The shape of the partition main body NG is a vertically elongated octagonal shape as viewed in a cross section along a direction toward the back substrate and opposing front substrate (not shown). An electric conducting layer CO is coated on the outer peripheral surface of the partition SPC. The size of this partition SPC has a radius of curvature of about 50 μm at an upper and lower edge portion E, a height of 3 mm±5 μm and a central portion width b of about 200 μm.

The partitions SPC constructed as above can be formed by redrawing a glass preform and can be elongated. It is therefore possible to improve yield and considerably improve productivity. The partitions having the central portion width b wider than the upper and lower end portion width W can retain a large strength. The partitions having a flat plane on their side walls can be mounted upright on the substrate plane and become hard to fall down, because a mount jig can be easily abutted on the flat plane. Since mounting the partition with the jig can be made easily and simply, the partition is hard to be bonded and fixed in a slanted state.

### Fourth Embodiment

FIG. 11 is a perspective view illustrating the structure of a partition SPC according to the fourth embodiment of the present invention. Like elements to those in the already described drawings are represented by identical reference symbols, and the description thereof is omitted. A different point of the partition from that shown in FIG. 10C resides in that conductive wires CW are inserted in the upper and lower end portions of the partition main body NG, the conductive wire having a wire diameter of several μm and made of aluminum material or alloy material of aluminum and other metal. The conductive wire CW can be formed easily by inserting aluminum or aluminum alloy at the same time when the partition main body NG is formed. An electric conducting layer CO is coated only on the outer peripheral surfaces in the upper and lower end portions of the partition main body NG.

With the above-described structure, charge-up of the partition SPC can be flowed out easily by electrically connecting the conductive wires CW inserted into the partition SPC to a ground line of, for example, a driver circuit installed in the apparatus. In this embodiment, although two conductive wires CW are inserted into the partition main body NG, one conductive wire CW may be inserted, with similar expected effects. The conductive wire CW may be cut into a plurality of conductive wire pieces in the partition main body NG, with similar expected effects.

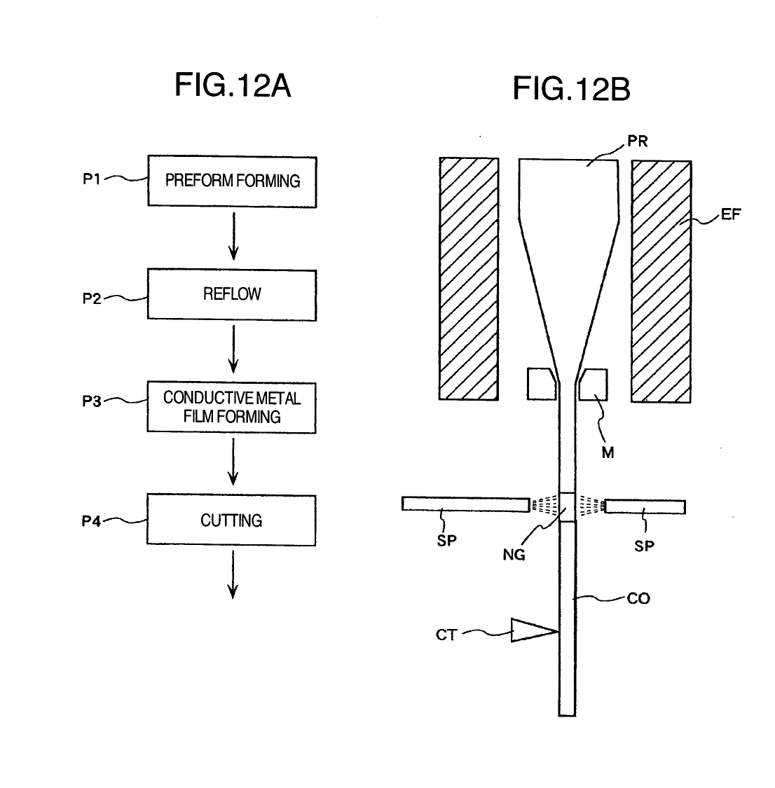

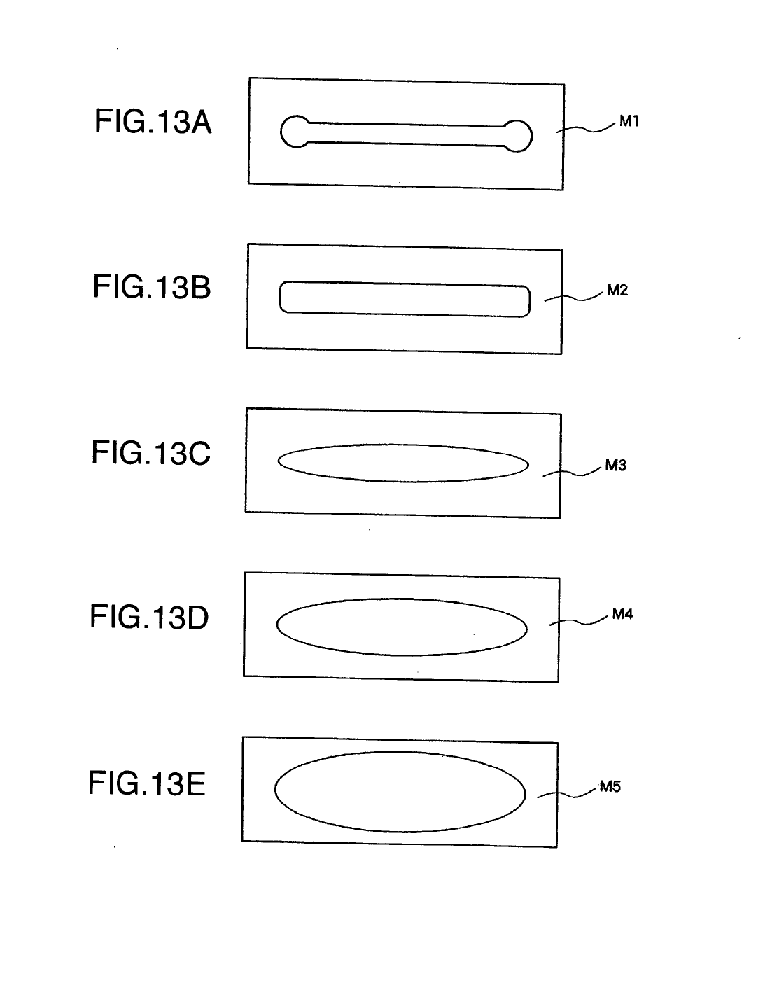

Next, description will be made on a partition manufacture method according to the present invention. FIGS. 12A and 12B and FIGS. 13A to 13E are diagrams illustrating an example of a manufacture method for each partition described above. FIG. 12A is a schematic diagram illustrating manufacture processes and FIG. 12B is a diagram showing the structure of a glass reflow system. FIG. 12A and 12B show the correspondence between the processes and system. FIGS. 13A to 13E are plan views of metal molds for forming various partitions. The manufacture method will be described with reference to FIGS. 12A and 12B.

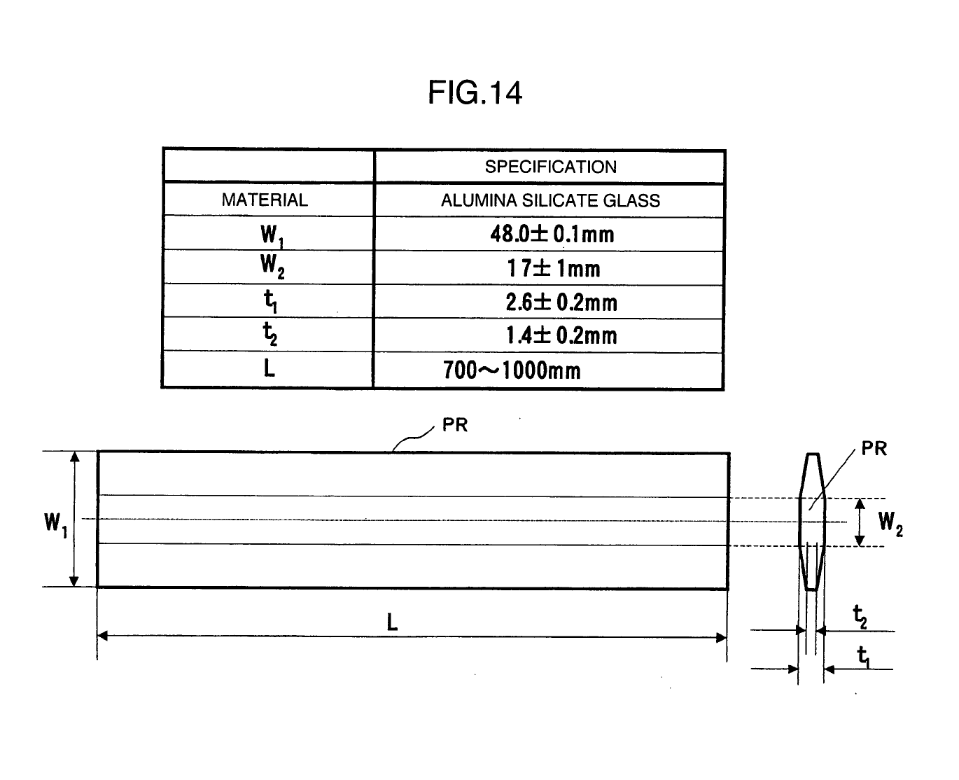

First, as shown in FIG. 12A, at Step P1 a preform PR of glass material containing rare-earth elements is formed, heated and melted in an electric furnace EF to a predetermined temperature. The brief shape of the glass preform is shown in FIG. 14. Next, at Step P2 the heated and melted preform PR is reflowed in a metal mold M (e.g., metal mold M1 shown in FIG. 13A) mounted on the bottom of the electric furnace EF by applying a predetermined pressure to form a stripe type partition main body NG. Next, at Step P3 binder containing conductive metal powder is blown from a spray gun SP to an outer peripheral surface of the stripe partition main body NG to form an electric conducting layer CO as a charge preventive coat.

Next, at Step P4 the stripe partition SPC with the conductive metal film CO formed on the surface thereof is cut by a predetermined length with a cutting tool CT to obtain a partition SPC having a desired length. The size of the partition SPC is about 110 mm long, about 3 mm high and about 0.1 mm wide, for example, for a 17-inch panel. Partitions SPC having different shapes described above can be formed by selectively using the metal molds M2 to M5 shown in FIGS. 13B to 13E as the metal mold M.

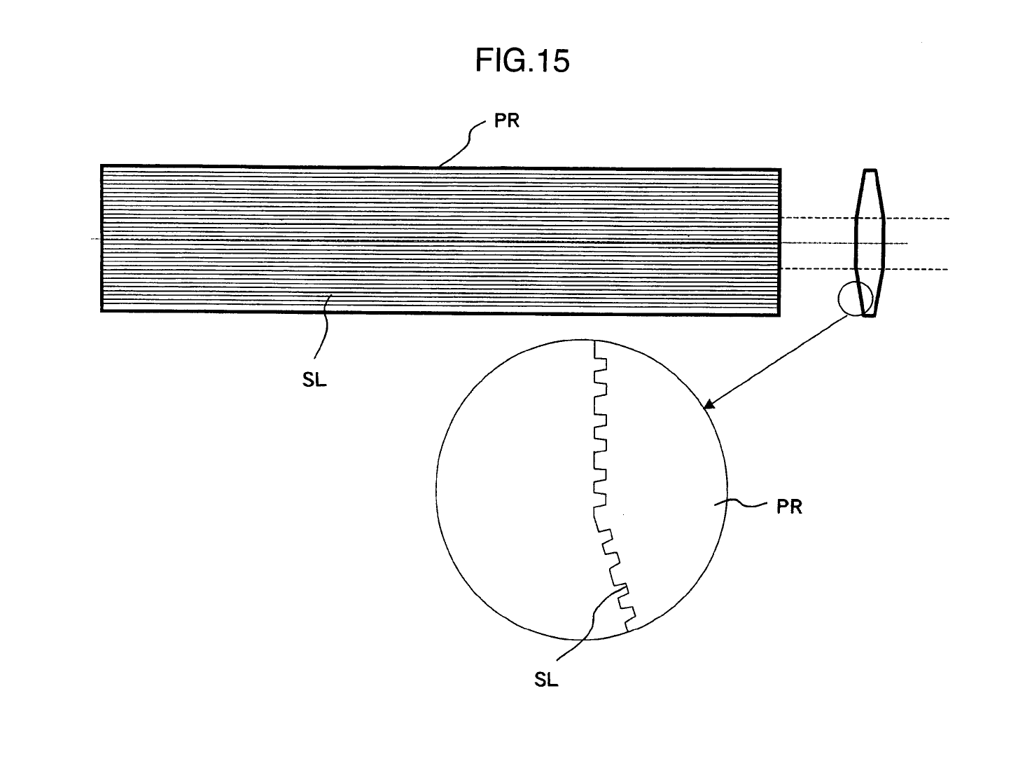

As shown in FIG. 15, slits SL are formed on the surface of the glass preform PR along a longitudinal direction so that the formed partition has concave/convex portions. For example, if about 1000 slits SL are formed on the glass preform PR, the concave/convex portions have a pitch of about 3 μm. With these concave/convex portions of about several μm, it becomes possible to prevent secondary electron emission to be caused by electrons emitted from an electron emission source toward the partition.

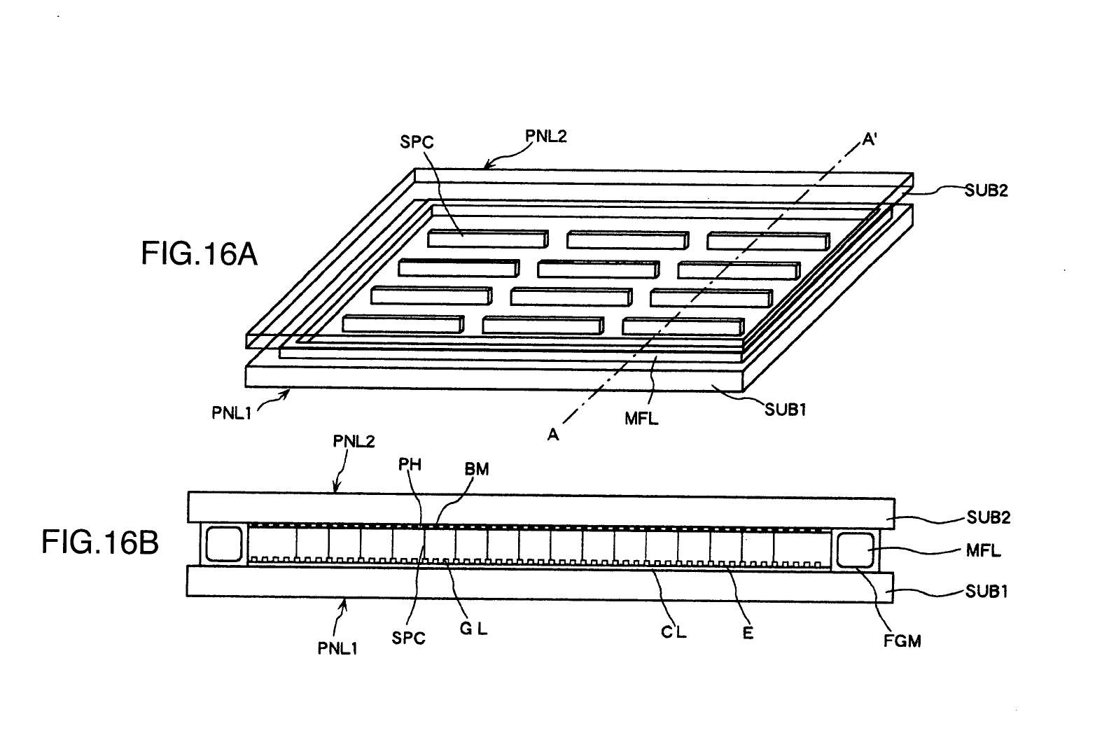

FIGS. 16A and 16B are diagrams illustrating an example of application of an image display apparatus of the present invention to a 17-inch type image display apparatus. FIG. 16A is a perspective view, and FIG. 16B is a cross sectional view taken along line A-A′ shown in FIG. 16A. In FIGS. 16A and 16B, cathode electrodes CL as data lines and gate electrodes GL as scan lines are formed on the inner surface of a back substrate SUB1 constituting a cathode panel PNL1, and an electron source E is formed at each cross point between the cathode electrodes CL and gate electrodes GL. A gate electrode lead wire (not shown) is connected to an end of each gate electrode GL.

A black matrix film, a metal back film (anode), fluorescent material layers PH and the like (respectively not shown) are formed on the inner surface side of a front substrate SUB2 constituting an anode panel PNL2. The back substrate SUB1 constituting the cathode panel PNL1 and the front substrate SUB2 constituting the anode panel PNL2 are bonded together by a sealing frame MFL at the peripheral edges by using a bonding material FGM. In order to retain a predetermined distance between the back substrate SUB1 and front substrate SUB. 2, partitions SPC of the above-described embodiments are mounted upright between both the substrates, each partition being constituted of a partition main body NG preferably made of glass material containing rare-earth elements and an electric conducting layer CO coated on at least a portion of the outer peripheral surface of the partition.

An inner space sealed by the cathode panel PNL1, anode panel PNL2 and sealing frame MFL is evacuated via an exhaust pipe (not shown) mounted on a partial area of the cathode panel PNL1 to maintain a predetermined vacuum state.

Table 3 shown below shows the evaluation results of panel assembly success factors of 16 samples of assembled 17-inch type image display apparatus by changing the glass material, b/2r and the number of partitions per inch. As seen from Table 3, it has been confirmed that under the same conditions of the number of total partitions, the number of partitions per inch and a total assembly time of partitions, the panel assembly success factor can be improved considerably by using glass material containing rare-earth elements, as compared to soda glass material. Namely, since the assembly success factor of the panel assembly process can be improved, the manufacture yield can be effectively improved.

TABLE 3

| | | | | | | panel |
|---|---|---|---|---|---|---|
| | | | | | total | assembly |
| | | | | number | partition | success |
| | | partition | total number | of partitions | aassembly | factor |
| | b (μm) | material | of partitions | per inch | time(s) | (n = 3) |
| Comparative | 100 | soda | 21 | 1.2 | 168 | 0.0 |
| example 1 | | glass | | | | |
| Comparative | 150 | soda | 21 | 1.2 | 168 | 0.0 |
| example 2 | | glass | | | | |
| Comparative | 200 | soda | 21 | 1.2 | 168 | 0.3 |
| example 3 | | glass | | | | |
| Comparative | 250 | soda | 21 | 1.2 | 168 | 0.3 |
| example 4 | | glass | | | | |
| Comparative | 100 | soda | 39 | 2.3 | 312 | 0.3 |
| example 5 | | glass | | | | |
| Comparative | 150 | soda | 39 | 2.3 | 312 | 0.3 |
| example 6 | | glass | | | | |
| Comparative | 200 | soda | 39 | 2.3 | 312 | 0.7 |
| example 7 | | glass | | | | |
| Comparative | 250 | soda | 39 | 2.3. | 312 | 0.7 |
| example 8 | | glass | | | | |
| Comparative | 100 | glass | 21 | 1.2 | 168 | 0.7 |
| example 9 | | containing | | | | |
| | | rare earth | | | | |
| | | element | | | | |
| Comparative | 150 | glass | 21 | 1.2 | 168 | 0.7 |
| example 10 | | containing | | | | |
| | | rare earth | | | | |
| | | element | | | | |
| Comparative | 200 | glass | 21 | 1.2 | 168 | 1.0 |
| example 11 | | containing | | | | |
| | | rare earth | | | | |
| | | element | | | | |
| Comparative | 250 | glass | 21 | 1.2 | 168 | 1.0 |
| example 12 | | containing | | | | |
| | | rare earth | | | | |
| | | element | | | | |
| Comparative | 100 | glass | 39 | 2.3 | 312 | 1.0 |
| example 13 | | containing | | | | |
| | | rare earth | | | | |
| | | element | | | | |
| Comparative | 150 | glass | 39 | 2.3 | 312 | 1.0 |
| example 14 | | containing | | | | |
| | | rare earth | | | | |
| | | element | | | | |
| Comparative | 200 | glass | 39 | 2.3 | 312 | 1.0 |
| example 15 | | containing | | | | |
| | | rare earth | | | | |
| | | element | | | | |
| Comparative | 250 | glass | 39 | 2.3 | 312 | 1.0 |
| example 16 | | containing | | | | |
| | | rare earth | | | | |
| | | element | | | | |

Table 4 shown below shows the evaluation results of a total manufacture cost, considering materials of partitions including glass material containing rare-earth elements, usual soda glass material, glass ceramic material and ceramic material, manufacture methods for these materials, mechanical strengths and the like. As seen from Table 4, it has been confirmed that by forming the partitions of glass material containing rare-earth elements by a redraw method, the partitions having a sufficiently high mechanical strength can be realized at low cost of about 10 Yen.

TABLE 4

| partition | manufacture | | | | |
|---|---|---|---|---|---|
| material | method | stength | cost | | remark |
| rare-earth | reflow | 250 MPa | ˜10 | Yen | |
| glass | method | | | | |
| soda-glass | reflow | 100 MPa | ˜10 | Yen | insufficient |
| | method | | | | strengh |
| | | | | | unapplicable |
| ceramics | greensheet | 300 MPa | ˜100 | Yen | expensive |
| glass | method | | | | bad yield |
| ceramics | | | | | |
| ceramica | hot pressing | 800 MPa | 2,000˜2500 | Yen | expensive |
| | method | | | | |

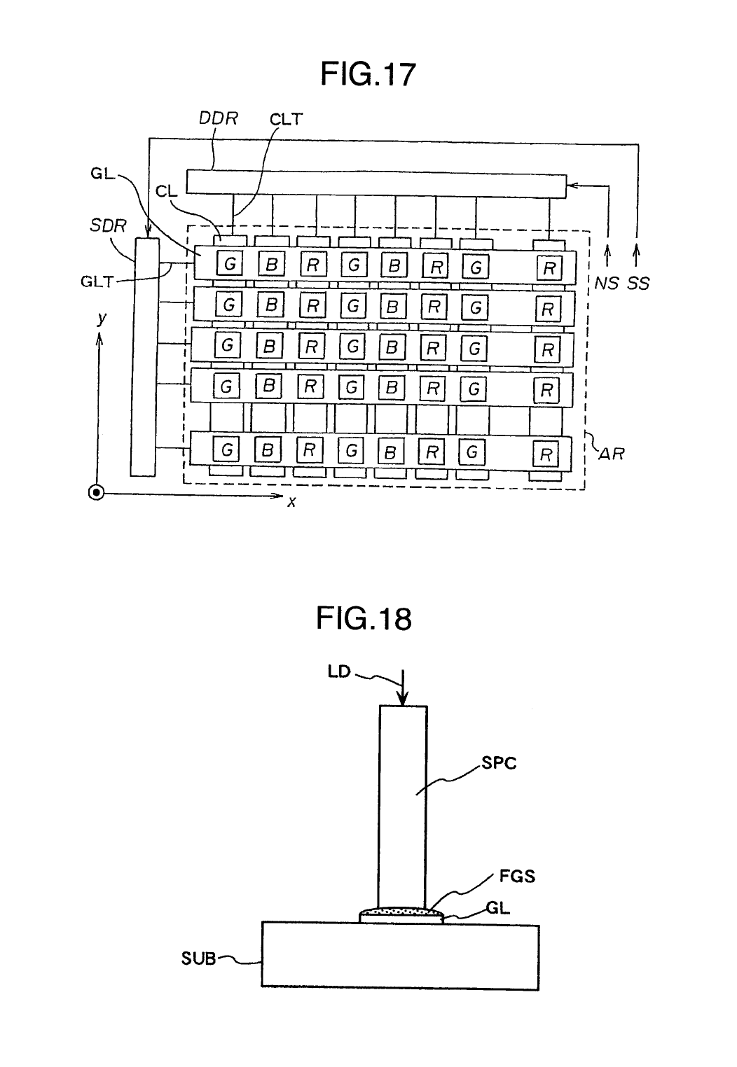

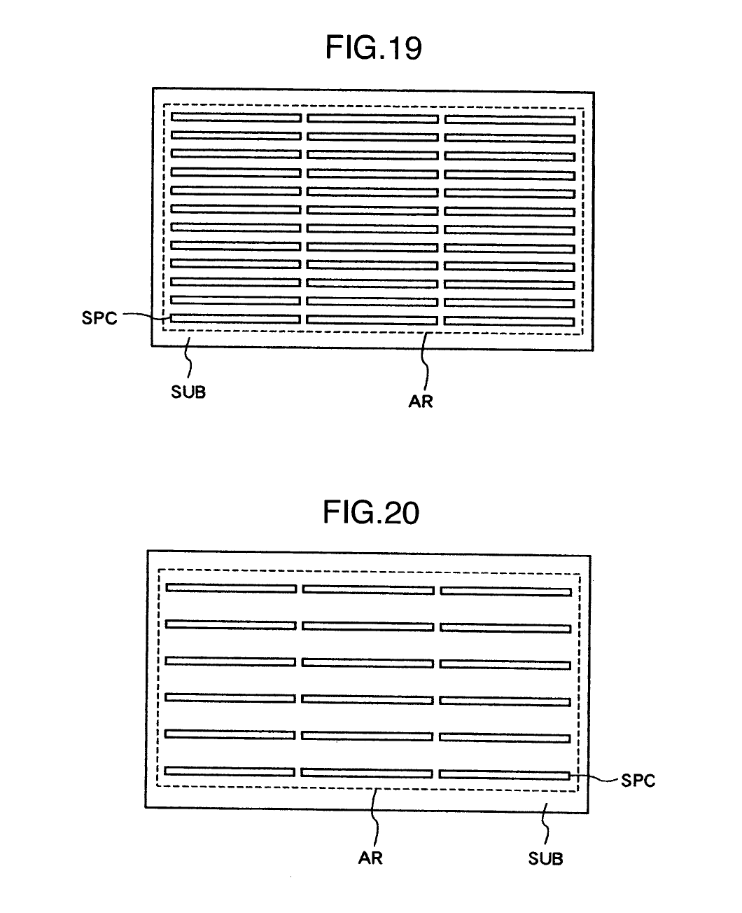

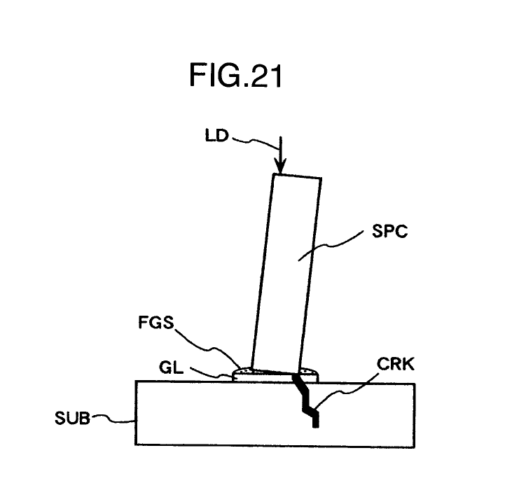

FIG. 17 is a diagram showing an example of an equivalent circuit of an image display apparatus to which the configuration of the present invention is applied. An area indicated by a broken line in FIG. 17 is a display area AR. In this display area, n cathode electrodes CL and m gate electrodes GL are disposed crossing each other to form an n x m matrix. Each cross point constitutes a sub-pixel, and a group of three unit pixels (or sub-pixels) “R”, “G” and “B” constitutes one color pixel. Electron sources are omitted in the drawing. The cathode electrode CL is connected to an image signal driver circuit DDR via a cathode electrode lead terminal CLT, and the gate electrode GL is connected to a scan signal driver circuit SDR via a gate electrode lead terminal GLT. An image signal NS is input to the image signal driver circuit DDR from an external signal source, and a scan signal SS is input to the scan signal driver circuit SDR via an external signal source.

As an image signal is supplied to the cathode electrodes CL crossing the sequentially selected gate electrodes GL, a two-dimensional full-color image can be displayed. By using the display panel constructed as above, a high efficiency image display apparatus can be realized at a relatively low voltage.

In the above-described embodiments, although the electron source of a MIM type has been described illustratively, the present invention is not limited thereto. It is obvious that the invention is also applicable to a fluorescent type flat panel display (FPD) using various types of electron sources described above, with expected quite similar effects described above.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus comprising:
a back panel having a display area with a number of pixels formed on a back substrate, said pixels including a number of first electrodes extending along a first direction and juxtaposed along a second direction crossing the first direction, an insulating layer covering said first electrodes, a number of second electrodes formed on said insulating layer, extending along the second direction and juxtaposed along the first direction, and an electron source disposed at each cross point between said first and second electrodes;
an anode panel having fluorescent material layers of a plurality of colors and a third electrode formed on a front substrate, said fluorescent material layers emitting light upon excitation of electrons emitted from said electron sources in said display area of said cathode panel;
a plurality of partitions for maintaining a distance between said cathode panel and anode panel at a predetermined distance by involving a fixing member between said panels in said display area; and
a sealing frame for air-tightly sealing said cathode panel and anode panel by involving a sealing material in peripheral areas of said panels,
wherein said partition includes a partition main body having curved portions at corners of upper and lower end portions contacting said cathode panel and anode panel and an electric conducting layer coated at least on the upper and lower end portions of said partition main body contacting said cathode panel and anode panel.

2. The image display apparatus according to claim 1, wherein said partition main body is a mold of glass material having SiO₂ as a main component and containing 1 to 20 wt. % of at least one material selected from a group consisting of La, Sc, Y, Ce, Pr, Nd, Pm, Sm, Eu, Gd, Tb, Dy, Ho, Er, Tm, Yb and Lu.

3. The image display apparatus according to claim 1, wherein said partition main body is made of the glass material having a flexural strength of 200 MPa or higher, a Weibull factor of 8.0 or higher and a Young's modulus of 70 Gpa or larger.

4. The image display apparatus according to claim 1, wherein said electric conducting layer is made of non-oxidizing metal.

5. The image display apparatus according to claim 1, wherein said partition has at least one conductive wire embedded in said partition main body along a longitudinal direction.

6. The image display apparatus according to claim 5, wherein said conductive wire is made of non-oxidizing metal.

7. The image display apparatus according to claim 6, wherein said conductive wire is connected to a ground line.

8. The image display apparatus according to claim 1, wherein said partition has a spherical portion at the upper and lower end portions of said partition main body contacting said cathode panel and anode panel, and said spherical portion is formed by coupling plate members.

9. The image display apparatus according to claim 1, wherein said partition main body of said partition is made of an ellipsoidal member whose central portion width is wider than a width of the upper and lower end portions as viewed in a cross section along said cathode panel and anode panel.

10. The image display apparatus according to claim 1, wherein said partition main body of said partition is made of a vertically elongated, generally octagonal member as viewed in a cross section along said cathode panel and anode panel, and opposite side walls of said generally octagonal member have flat surfaces along a direction from said electron source toward said third electrode.
